(19) United States
(12) Patent Application Publication
(10) Pub. No.: US 2006/0125658 A1
(43) Pub. Date: Jun. 15, 2006

(54) System for assisting navigation operation of moving objects

(75) Inventors: Hans-Ullrich Dohler, Braunschweig (DE); Bernd Korn, Lehre (DE)

Correspondence Address: FOLEY AND LARDNER LLP;SUITE 500, 3000 K STREET NW, WASHINGTON, DC, 20007, US

(73) Assignee: DEUTSCHES ZENTRUM FOR LUFT-UND RAUMFAHRT E.V.

(21) Appl. No.: 11/008,575

(22) Filed: Dec. 10, 2004

(51) Int. Cl. B64F 1/20; G05D 1/12

(52) U.S. Cl. 340/951; 244/186

(57) ABSTRACT

A system for assisting in navigation operation of moving objects on a predefined track is disclosed comprising a plurality of first infrared light emitters for emitting infrared light over a first range of wavelengths in restricted angles of radiation, and a plurality of a second infrared light emitters for emitting infrared light over a second range of wavelengths in restricted angles of radiation, where the first and second ranges are at least partially non-overlapping, said first and second infrared light emitters are placed in respective positions to a guide way in groups with respective angles of radiation, set such that a first set of infrared light patterns of combined groups of first and second wavelengths are visible for a controller by means of a infrared light vision system at the moving object, when the moving object matches the track, and that one or more second sets of infrared light patterns of combined groups of first and second wavelengths are visible for the controller, when the position of the moving object is outside the track.

### BACKGROUND OF THE INVENTION

1. Field of the Invention

The present invention broadly relates to a system for assisting navigation operations of moving objects along a predefined course and in one embodiment to a precision approach path indicator (PAPI) or a visual approach slope indicator (VASI) system for assisting a landing operation of aircrafts on a predefined glide slope to a runway.

2. Description of Related Art

An aircraft landing on a runway should approach the runway on a predefined glide slope in order to avoid early or late grounding in front of or after the touchdown zone of the runway.

Optical approach slope indicators are well known in the prior art. The GB 2 095 012 A discloses an approach slope indicator in a PAPI projection unit arranged to emit an array of distinguishable visible light beams. The beams comprise a correct approach pass beam, a too low approach beam, and a dangerously low approach pass beam in descending height order. The correct approach pass beam includes an identification signal. Light patterns may include red, green, blue or white light.

In the visible light systems of GB 2 095 12 A, visibility of the runway lights for the pilot is disadvantageously reduced in bad weather conditions.

Further, instrumental landing systems (ILS's) are well known in the prior art in order to allow for an automated landing process. For military use, precision radar for guiding approaching airplanes are commonly known.

A combined portable aircraft landing light system is disclosed in U.S. Pat. No. 6,567,248 B1 having three modalities that can be controlled manually or remotely. The modalities are visible light, infrared light and forward looking infrared (FLIR) emission.

A combined diffuse incandescent runway marker light apparatus having a housing with a visible light diffusing plate mounted in one end and an infrared light diffusing plate mounted in the other hand is disclosed in the U.S. Pat. No. 4,554,544.

U.S. Pat. No. 4,210,930 discloses an approach system with simulated display of runway lights and glide slope indicator. The approach system includes a microwave energy source detector. Visual Approach Slope Indicators (VASI's) are read out by use of microwave signals when the visible light emitted from a VASI system at the runway is invisible due to bad weather conditions. The VASI's of U.S. Pat. No. 4,210,930 are arranged such that defined visual light patterns are detectable by a pilot when the aircraft is on the glide slope or approaches the glide slope on a correct track. In case the aircraft is outside the glide slope or approaches the glide slope on a wrong track, no or other visual light patterns are visible.

At present, only the instrumental landing system ILS is used in civil aircrafts during bad weather conditions, e.g., fog. Depending on the visual range (CAT-1, CAT-2, CAT-3) different conditions are set for the approach systems. These conditions must be fulfilled by components on the aircraft as well as by the components at the runway.

An improved vision system sensitive to infrared radiation is proposed in the U.S. Pat. No. 6,373,055 B1, wherein the signal from a first imager sensitive to infrared radiation of less than 2 μm in wavelength and from a second imager sensitive to infrared radiation of at least 3 μm in wavelength is combined by a signal processor to an image signal representing locally maximum values of the first and second image signal to create a displayed image. By processing two nonoverlapping ranges of infrared wavelengths separately, a broad dynamic range is allocated to the signal generated by each of the detectors without concern for the dynamic range required by the other of the detectors. The vision system is also called bi-forward-looking infrared camera (bi-FLIR).

The conventional precision approach path indicator systems (PAPI) or visual approach slope indicator systems (VASI) are defined in detail in International Standards and Recommended Practices, Aerodromes, Annex 14 to the Convention on International Civil Aviation, Volume I—Aerodrome Design and Operation, 3rd edition, July 1999, International Civil Aviation Organization ICAO.

### SUMMARY OF THE INVENTION

In accomplishing an object of the invention, there has been provided, according to one aspect of the invention, a system for assisting in navigation of a moving object along a predefined course, comprising a plurality of first infrared light emitters for emitting infrared light (i) over a first range of wavelengths and (ii) within a first fixed range of angles of radiation; and a plurality of second infrared light emitter for emitting infrared light (i) over a second range of wavelengths and (ii) within a second fixed range of angles of radiation; wherein the first and second ranges of wavelengths are at least partially non-overlapping; and wherein the first and second infrared light emitters are positioned in groups with respect to the predefined course and emit light within, respectively, the first fixed range and the second fixed range of angles of radiation such that (i) a first infrared light pattern of the first and second infrared light emitters is visible for a controller of the moving object by an infrared light detection system at the moving object when the moving object matches the predefined course, and such that (ii) one or more second sets of infrared light patterns of combined groups of first and second infrared light emitters are visible for the controller by the infrared light detection system, when the position of the moving object is outside the predefined course.

In addition there has been provided, according to another aspect of the invention, an approach slope indicator system for assisting in landing operations of aircrafts along a predefined glide slope to a runway, comprising a plurality of first infrared light emitters for emitting infrared light over a first range of wavelengths within a first fixed range of angles of radiation, and a plurality of second infrared light emitters for emitting infrared light over a second range of wavelengths within a second fixed range of angles of radiation, wherein the first and second ranges are at least partially non-overlapping, and wherein the said first and second infrared light emitters are placed in groups in positions with respect to the runway with the first and second fixed angles of radiation set (i) such that a first set of infrared light patterns of combined groups of first and second infrared light information are visible for a pilot by an infrared light detection system at the aircraft, when the aircraft matches the glide slope, and (ii) such that one or more second sets of infrared light patterns of combined groups of first and second infrared light information are visible for a pilot by the infrared light detection system, when the aircraft position is outside the glide slope.

In accordance with another aspect of the present invention, there as been provided, an infrared light vision system, comprising a first infrared detector sensitive to infrared radiation in a first range of wavelengths, a second infrared detector sensitive to infrared radiation in a second range of wavelengths, and a signal processor operatively associated with the first and second infrared detector and a display, said signal processor provided to combine an image signal representing (i) a focused infrared radiation point detected by the first infrared detector in a first visible color on said display and (ii) a focused infrared radiation point detected by the second infrared detector in a second visible color on the display.

In accordance with yet another aspect of the present invention, there has been provided a course marker light apparatus, comprising a housing having an aperture which permits light to pass from the inside of the housing to the outside, a first infrared light emitter for emitting infrared light over a first range of wavelengths arranged inside the housing, a second infrared light emitter for emitting infrared light over a second range of wavelengths arranged inside the housing, a first infrared light filter which permits light within the first range of wavelengths to pass through, and a second infrared light filter which permits light within the second range of a wavelengths to pass through, wherein the first and second infrared light filters are arranged in a position relative to the aperture such that a first range of angles of radiation of infrared light which passes through the first infrared light filter and a second range of angles of radiation of infrared light which passes through the second infrared light filter are at least partially non-overlapping.

Further objects, features and advantages of the present invention will become apparent from the detailed description of preferred embodiments that follows when considered with the accompanying drawings.

### BRIEF DESCRIPTION OF THE DRAWINGS

The invention is explained in detail below with reference to the exemplary embodiments and with reference to the accompanying drawings, in which:

FIG. 1 is a schematic top view of a group of color coded information nearby a runway dependent on the position of an aircraft on a glide slope (VASI);

FIG. 2 is a second group of color coded information nearby a runway depending on the position of an aircraft relative to a glide slope to the runway (PAPI);

FIG. 3 is schematic view of a track marker light apparatus comprising a first and second infrared light emitter and infrared light filters;

FIG. 4 is a schematic view of a second track marker light apparatus comprising a first infrared light emitter for emitting infrared light over a first range of wavelengths in a first angle of radiation;

FIG. 5 is schematic view of a third track marker light apparatus comprising a second infrared light emitter for emitting infrared light over a second range of wavelengths in a second angle of radiation; and

FIG. 6 is a block diagram of an infrared light vision system for use in a vehicle or aircraft in combination with an infrared light emitter system.

### DETAILED DESCRIPTION OF PREFERRED EMBODIMENTS

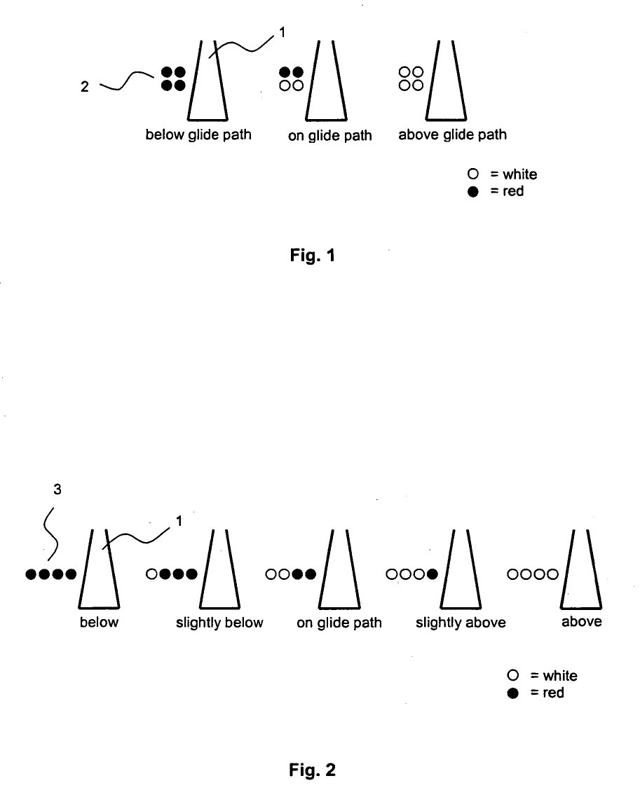

Turning now to the drawings, FIG. 1 shows a top view onto a runway 1 from an aircraft approaching said runway 1. In this exemplary depiction, a group 2 of visual light emitters are arranged adjacent to a runway 1 in order to show color coded information to a pilot. The color coded information changes depending on the position of the aircraft relative to a glide slope. In a conventional VASI system, if the aircraft position is below the glide slope, four red lights are visible for the pilot. If the aircraft position is on the predefined glide slope, two horizontally parallel white lights and, behind the white lights, two horizontally parallel red lights are visible for the pilot. If the aircraft position is above the glide slope, four white lights arranged in a square are visible for the pilot. In both FIG. 1 and FIG. 2, the white circles depict white colored lights and the black circles depict red colored lights.

According to an embodiment of the present invention, infrared light emitters are arranged so that one or more first infrared light emitters for emitting infrared light at restricted angles of radiation over a first range of wavelengths, such as, for example, in a range of 1 to 5 μm, and one or more second infrared light emitters for emitting infrared light at restricted angles of radiation over a second range of wavelengths, such as, for example, in the range of 8 to 13 μm, are positioned in respective groups at the runway 1 or near the runway. The first and second ranges of wavelength are at least partially non-overlapping in order to provide at least two different sets of infrared wavelength coded information for a pilot detecting the infrared light on an aircraft approaching the runway 1. The position of the first and second infrared light emitters and the respective angles of radiation of said first and second infrared light emitters are set so that an infrared light pattern similar to those shown in FIG. 1 can be made visible for a pilot, when the aircraft position is on the glide slope, and so that one or more second sets of infrared light patterns as shown in FIG. 1 can be made visible for the pilot, when the aircraft position is below or above the glide slope.

According to an embodiment of the invention, infrared light emitters are used and positioned for detection by an infrared light system on an aircraft in addition to or instead of visual light emitters commonly known for visual approach slope indicators VASI. One of advantage of this arrangement is that the pilot is able to use the visual approach slope indicator system even in bad weather conditions using the same information codes used in good weather conditions.

FIG. 2 shows a second embodiment wherein four color or infrared lights code information for a precision approach path indicator system (PAPI). In this embodiment, the groups 3 of light emitters are arranged at or near the runway 1. The light information points are arranged in a horizontal line extending at right angles to the longitudinal direction of the runway 1.

In a conventional PAPI system which emits red and white visible light, four red lamps are visible for a pilot when the aircraft position is below the glide slope. In FIG. 2, solid black circles depict red lights and white circles depict white lights. If the aircraft position is slightly below the glide slope, the left lamp is visible as a white light, whereas the three other lamps at the right side of the white lamp are visible as red lights. If the aircraft position is on the glide slope, the two lamps at the left side of the chain of four lamps appear as white lights for a pilot and the two lamps and the right side of the chain of the four lamps appear as red lights for the pilot. If the aircraft position is slightly above the glide slope, only the right lamp of the chain of four lamps appears as a red light, whereas the three other lamps at the left side of the chain of lights appear as white lights. In conventional PAPI systems all fours lamps appear as white light for a pilot, if the aircraft position is above the glide slope.

According to an embodiment of the present invention, each group of infrared light emitters arranged at or near the runway 1 comprises four infrared light emitters for emitting infrared light in restricted angles over the first range of wavelengths and four second infrared light emitters for emitting infrared light in restricted angles over the second range of wavelengths. The respective positions of the first and second infrared light emitters in said group and the respective angles of radiation are chosen such, that coded information similar to that shown in FIG. 2 is made visible for a pilot from the infrared light detected at the aircraft by infrared light detectors, which are directed to the group of first and second infrared light emitters.

In on exemplary embodiment Short Wave Infrared light SWIR, for example, infrared light in the range of 1 to 5 μm, may be used as the first range of wavelengths and replace the red colored lights discussed above. Long Wave Infrared light LWIR, for example, infrared light in the range of 8 to 13 μm, which is emitted by the second infrared light emitters may be used as the second range of wavelengths and replace the white colored lights discussed above.

The positions for the first and second infrared light emitters and the angles of radiation may be adjusted to the operational glide slope for a runway 1, as is the present practice for existing PAPI installation and maintenance.

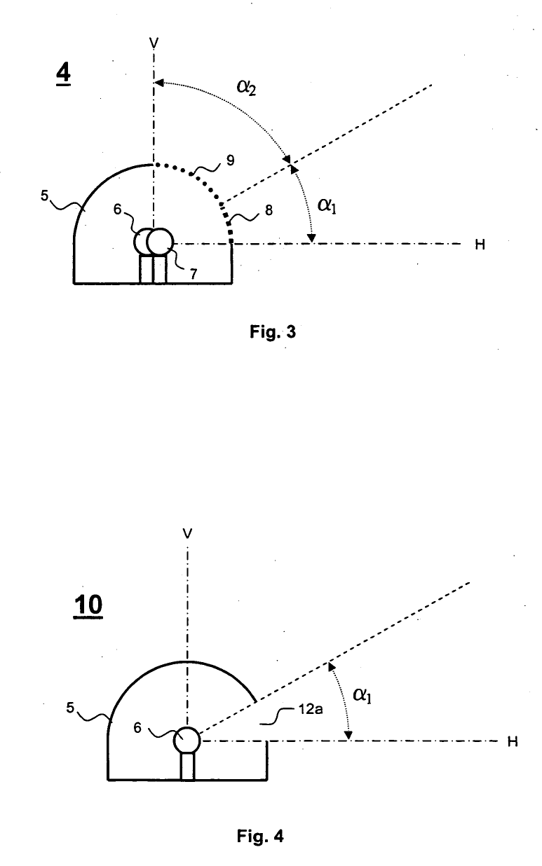

FIG. 3 shows a schematic side plan view of a track marker light apparatus 4 according to an embodiment of the present invention for use in an infrared approach slope indicator system (VASI or PAPI). The track marker light apparatus 4 comprises a housing 5 incorporating a first infrared light emitter 6 for emitting a light over the first range of wavelengths and a second infrared light emitter 7 for emitting infrared light over a second range of wavelengths. As explained above, the first and second ranges of wavelengths are at least partially nonoverlapping and more preferrably fully non-overlapping. In order to achieve reliable discrimination between the first and second infrared light emitters 6 and 7 from the view of the pilot or airplane approaching the runway 1, the amount of light in the first range of wavelengths in the second light detected by a first detector for the range of wavelengths should be attenuated for at least 20 dB and the amount of light in the second range of wavelengths which is detectable in the light detected by a second detector for the first range of wavelengths should be attenuated for at least 20 dB. That is, the amount of light in one range of wavelengths present in the detected amount of light for the other range of wavelengths should be less than 10% of the respective detected amount of light in the other range of wavelength.

The housing 5 has an aperture extending from a horizontal plane H to a vertical plane V from the first and second infrared light emitters 6, 7. A first infrared light filter 8 is arranged in the aperture, where the first infrared light filter is provided to pass infrared light in the first range of wavelengths and to partially or more preferably fully stop infrared light in the second range of wavelengths. The first infrared light filter 8 is arranged in such a position, that the infrared light in the first range of wavelengths passes the housing 5 in an angle of radiation α₁, extending from the horizontal plane in the direction of the vertical plane.

A second infrared light filter 9 is arranged in the aperture of the housing 5, said second infrared light filter 9 is provided for passing infrared light in the second range of wavelengths and at least partially and more preferably fully stopping infrared light in the first range of wavelengths. The second infrared light filter 9 is arranged in the aperture of the housing 5 such, that infrared light in the second range of wavelengths is emitted from the track marker light apparatus 4, when the second infrared light emitter 7 is turned on, in a second angle of radiation α₂, which follows the first angle of radiation α₁ and extends in the directions of the vertical plane V.

The angle α₁ of each installed infrared VASI or PAPI element has to be tuned to the glide path angle of the operational runway, as it is presently carried out for installation and maintenance of existing VASI and PAPI systems. For a glide slope angle of 3° the above referenced ICAO annex 14 manual defines the following angles α₁, for each PAPI element.

1. lamp: α₁=2.50°

2. lamp: α₁=2.83°

3. lamp: α₁=3.16°

4. lamp: α₁=3.50°

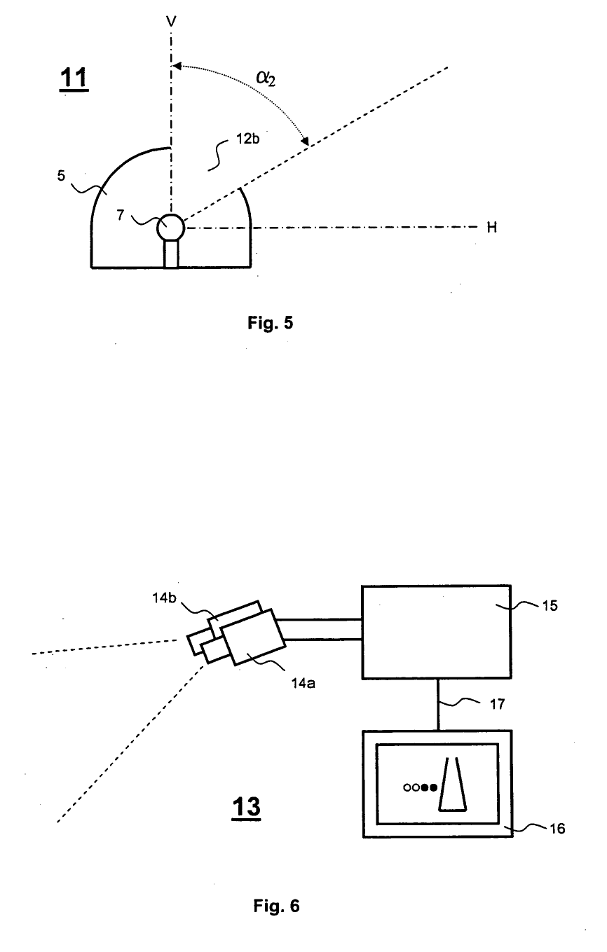

FIGS. 4 and 5 depict a second and third track marker light apparatus 10 and 11 without said infrared light filters 8 and 9 mentioned above.

Each housing 5 of the second or third marker light apparatus 10 or 11 incorporates either the first infrared light emitter 6 for emitting infrared light over the first range of wavelengths or a second infrared light emitter 7 for emitting infrared light over the second range of wavelengths. An aperture 12a, 12b is provided in the housing 5 so that infrared light in the first or second range of wavelengths, respectively, is emitted from the track marker light apparatus 10, 11 in a first angle of radiation α₁ or a second angle of radiation α₂, which follows the first angle of radiation α₁ immediately in the direction of a vertical plane extending from the track marker light apparatus 10, 11.

FIG. 6 shows a block diagram of an infrared light vision system 13 for use in an infrared approach slope indicator system for guiding aircraft to a runway during landing approach in accordance with an embodiment of the present invention. The infrared light vision system 13 comprises a first infrared detector 14a and a second infrared detector 14b, wherein the first infrared detector 14a is sensitive to infrared radiation in a first range of wavelengths and the second infrared detector 14b is sensitive to infrared radiation in the second range of wavelengths, wherein the first and second ranges of wavelengths are at least partially and, more preferably, fully nonoverlapping.

A signal processor 15 is operatively associated with the first and second infrared detectors 14a, 14b and with a display 16. The signal processor 15 is provided to combine an image signal 17 for the display 16 representing focused infrared radiation points detected by the first infrared detector 14a in a first visible color such as, for example, white color, on the display 16 and focused infrared radiation points detected by the second infrared detector 14b in a second visible color such as, for example, red, on the display 16.

The signal processor 15 can be provided in a preferred embodiment to combine the image signal 17 representing focused infrared radiation points detected by the first infrared detector 14a and the second infrared detector 14b together at a time on a common place in a third visible color, such as, for example, green, on the display 16.

Thus, the signal processor 15 is provided to transform the infrared light in the first and/or second range of wavelengths emitted by the first and second light emitters 6, 7 into visual color coded information on the display in order to allow an easy recognition by a pilot of the position of the aircraft relative to a glide slope to a runway 1 using an infrared light system arranged according to currently known visual approach slope indicator systems using visible light.

An aspect of the present invention provides an improved system for assisting navigation operations of moving objects on a predefined track and in one embodiment a visual approach slope indicator system for assisting landing operations of aircrafts on a predefined glide slope to a runway. The system provides for landing of an aircraft on a runway by use of light pattern even under bad weather conditions, where light in the range of visible wavelengths is invisible for a pilot. The infrared light patterns provided by the present invention are arranged according to light patterns, which are known from precision approach path indicator systems (PAPI) and visual approach slope indicator systems (VASI).

Accordingly, this aspect of the present invention is directed to a system for assisting navigation operations of moving objects like vehicles, aircrafts or vessels along a predefined course comprising a plurality of first infrared light emitters for emitting infrared light over a first range of wavelengths in restricted angles of radiation, and a plurality of second infrared light emitters for emitting infrared light over a second range of wavelengths in restricted angles of radiation, where the first and second ranges are at least partially non-overlapping, said first and second infrared light emitters are placed in respective positions to the runway in groups with respective angles of radiation, set such that a first set of infrared light patterns of combined groups of first and second wavelengths are visible for a pilot by means of a infrared light vision system at the aircraft, when the aircraft matches the glide slope, and that a second set of infrared light patterns of combined groups of first and second wavelengths are visible for a pilot, when the aircraft position is outside the glide slope.

Another aspect of the presently disclosed invention relates to a precision approach path indicator (PAPI) or visual approach slope indicator (VASI) system for assisting in landing operations of aircrafts on a predefined glide slope to a runway comprising a plurality of first infrared light emitters for emitting infrared light over a first range of wavelengths in restricted angles of radiation and a plurality of second infrared light emitters for emitting infrared light over a second range of wavelengths in restricted angles of radiation, where the first and second ranges are at least partially nonoverlapping, said first and second infrared light emitters are placed in respective position to the runway in groups with respective angles of radiation, set such that a first set of infrared light patterns of combined groups of first and second wavelengths are visible for a pilot by means of a infrared light vision system at the aircraft when the aircraft matches the glide slope, and that the second set of infrared light patterns of combined groups of first and second wavelengths are visible for a pilot, when the aircraft position is outside the glide slope.

A further aspect of the disclosed invention relates to an infrared light vision system comprising a first infrared detector sensitive to infrared radiation in a first range of wavelengths, a second infrared detector sensitive to infrared radiation in the second range of wavelengths, a signal processor operatively associated with the first and second infrared detector and with the display, said signal processor provided to combine an image signal representing focused infrared radiation points detected by the first infrared detector in a first visible color on said display and focused infrared radiation points detected by the second infrared detector in a second visible color on said display. Said infrared light vision system is intended for use in combination with the system for assisting navigation operations or the visual approach slope indicator system.

Yet another aspect of the present invention relates to a track marker light apparatus comprising a housing having apertures for passing through light from the inside of the housing to the outside, a first infrared light emitter for emitting infrared light over a first range of wavelengths inside the housing, a second infrared light emitter for emitting infrared light over a second range of wavelengths inside the housing, a first infrared light filter for passing through the first range of wavelengths, and a second infrared light filter for passing through second range of wavelengths, said first and second infrared light filters are arranged in positions relative to the aperture such that the angle of radiation of infrared light passing the filter in the first range of wavelengths is at least partially non-overlapping with the angle of radiation of infrared light passing through the filter and the second range of wavelengths.

The track marker light apparatus is intended for use in the system for assisting navigation operations or the approach slope indicator system. The track marker light apparatus provides an infrared light emitter detectable by the infrared light vision system.

The foregoing embodiments have been shown for illustrative purposes only and are not intended to limit the scope of the invention which is defined by the claims.

What is claimed is:

1. A system for assisting in navigation of a moving object along a predefined course, comprising:
(a) a plurality of first infrared light emitters for emitting infrared light (i) over a first range of wavelengths and (ii) within a first fixed range of angles of radiation; and
(b) a plurality of second infrared light emitter for emitting infrared light (i) over a second range of wavelengths and (ii) within a second fixed range of angles of radiation,
wherein the first and second ranges of wavelengths are at least partially non-overlapping; and
wherein the first and second infrared light emitters are positioned in groups with respect to the predefined course and emit light within, respectively, the first fixed range and the second fixed range of angles of radiation such that (i) a first infrared light pattern of the first and second infrared light emitters is visible for a controller of the moving object by an infrared light detection system at the moving object when the moving object matches the predefined course, and such that (ii) one or more second sets of infrared light patterns of combined groups of first and second infrared light emitters are visible for the controller by the infrared light detection system, when the position of the moving object is outside the predefined course.

2. A system according to claim 1, wherein the first range of wavelengths and the second range of wavelengths do not overlap.

3. A system according to claim 1, wherein the first range of wavelengths is in the range of 1 to 5 μm and the second range of wavelengths is in the range of 8 to 13 μm.

4. A system according to claim 1, wherein the amount of light in the first range of wavelengths that is detectable in the second range of wavelengths is attenuated for a least 20 dB and the amount of light in the second range of wavelengths detectable in the first range of wavelengths in attenuated for at least 20 dB.

5. A system according to claim 1, wherein the infrared light in the first range of wavelengths emitted by the first infrared light emitters forms a first color signal point of information for the controller of the moving object, the infrared light in the second range of wavelengths emitted by the second infrared light emitters forms a second color signal point of information and the combined mixtures of infrared light in the first and second range of wavelengths emitted by the first and second infrared light emitters forms a third color signal point of information.

6. An approach slope indicator system for assisting in landing operations of aircrafts along a predefined glide slope to a runway, comprising:
a plurality of first infrared light emitters for emitting infrared light over a first range of wavelengths within a first fixed range of angles of radiation, and
a plurality of second infrared light emitters for emitting infrared light over a second range of wavelengths within a second fixed range of angles of radiation,
wherein the first and second ranges are at least partially non-overlapping,
wherein the first and second infrared light emitters are positioned in groups with respect to the runway and emit light within, respectively, the first and second fixed range of angles of radiation (i) such that a first infrared light pattern of the first and second infrared light emitters is visible for a pilot of the aircraft by an infrared light detection system at the aircraft, when the aircraft matches the glide slope, and (ii) such that one or more second sets of infrared light patterns of combined groups of first and second infrared light emitters are visible for the pilot by the infrared light detection system, when the aircraft position is outside the glide slope.

7. An approach slope indicator system according to claim 6, wherein said first range of wavelengths is in the range of 1 to 5 μm and the second range of wavelengths is in the range of 8 to 13 μm.

8. An approach slope indicator system according to claims 6, wherein the first range of wavelengths and the second range of wavelengths do not overlap.

9. An approach slope indicator system according to claim 1, wherein the amount of light in the first range of wavelengths which is detectable in the second range of wavelengths is attenuated for 20 dB and the amount of light in the second range of wavelength which is in the first range of wavelengths is attenuated by 20 dB.

10. An approach slope indicator system according to claim 1, wherein the infrared light in the first range of wavelengths emitted by the first infrared light emitters forms a first color signal point of information for the pilot, wherein the infrared light in the second range of wavelengths emitted by the second infrared light emitters forms a second color signal point information and the combined mixture of infrared light in the first and second range of wavelengths emitted by the first and second infrared light emitters forms a third color signal point of information.

11. An infrared light vision system, comprising:
a first infrared detector sensitive to infrared radiation in a first range of wavelengths,
a second infrared detector sensitive to infrared radiation in a second range of wavelengths, and
a signal processor operatively associated with the first and second infrared detector and a display, said signal processor provided to combine an image signal representing (i) a focused infrared radiation point detected by the first infrared detector in a first visible color on said display and (ii) a focused infrared radiation point detected by the second infrared detector in a second visible color on the display.

12. An infrared light vision system according to claim 11, wherein said signal processor is provided to combine the image signal representing focused infrared radiation points detected by the first infrared detector as well as by the second infrared detector in a third visible color on the display.

13. An infrared light vision system according to claim 11, wherein an infrared light emitter capable of emitting infrared light in a first wavelength range which is detectable by the first infrared detector and an infrared light emitter capable of emitting infrared light in a second wavelength range which is detectable by the second infrared detector, wherein the focused infrared radiation point is detected by the first infrared detector and wherein the focused infrared radiation point is detected by the second infrared detector.

14. A course marker light apparatus, comprising:
a housing having an aperture which permits light to pass from the inside of the housing to the outside,
a first infrared light emitter for emitting infrared light over a first range of wavelengths arranged inside the housing,
a second infrared light emitter for emitting infrared light over a second range of wavelengths arranged inside the housing,
a first infrared light filter which permits light within the first range of wavelengths to pass through, and
a second infrared light filter which permits light within the second range of a wavelengths to pass through,
wherein the first and second infrared light filters are arranged in a position relative to the aperture such that a first range of angles of radiation of infrared light which passes through the first infrared light filter and a second range of angles of radiation of infrared light which passes through the second infrared light filter are at least partially non-overlapping.

15. A course marker light apparatus according to claim 14, wherein the first and second range of angles of radiation are set such that a first infrared light pattern is detectable from a position on the course relative to the marker light apparatus and that a second infrared light pattern is detectable from a position outside the course relative to the marker light apparatus.

16. A course marker light apparatus a cording to claim 14, wherein the first range of wavelengths is in the range of 1 to 5 μm and the second range of wavelengths is in the range of 8 to 13 μm.

17. A course marker light apparatus according to claim 14, wherein the first range of wavelengths and the second range of wavelengths do not overlap.

18. A course marker light apparatus according to claim 14, wherein the amount of light in the first range of wavelengths which is detectable in the second range of wavelengths is attenuated for at least 20 dB and the amount of light in the second range of wavelengths which is detectable in the first range of wavelengths in attenuated for at least 20 dB.
